(19) United States
(12) Patent Application Publication
(10) Pub. No.: US 2025/0326167 A1
(43) Pub. Date: Oct. 23, 2025

(54) SINGLE-COMPONENT INJECTION MOLDED VIAL WITH INTEGRAL MALE LUER LOCK FITTING FOR FLUID PRODUCTS, SUCH AS MEDICAL, PHARMACEUTICAL, COSMETIC, FOOD PRODUCTS OR THE LIKE

(71) Applicant: Lameplast, S.r.l., Novi di Modena (MO) (IT)

(72) Inventors: Filippo FANGAREZZI, San Martino di Mugnano (IT); Davide ANDREETTO, Este (PD) (IT); Monica FOGLIO STOBBIA, Novellara (RE) (IT)

(21) Appl. No.: 19/177,783

(22) Filed: Apr. 14, 2025

Related U.S. Application Data
(60) Provisional application No. 63/635,075, filed on Apr. 17, 2024.

(51) Int. Cl. B29C 45/14; B01L 3/00; B29C 45/04; B29C 45/40; B29L 23/20

(52) U.S. Cl. CPC B29C 45/14754; B01L 3/565; B29C 45/0441; B29C 45/40; B29C 2045/1477; B29C 2045/4078; B29L 2023/20

(57) ABSTRACT

A single component, multi-purpose injection molded plastic vial with a male luer lock fitting for use in multiple applications including filling, sealing, storage and delivery of various fluid products, in particular the dosage of medical and pharmaceutical fluid products.

### FIELD OF THE INVENTION

This application relates to a single component, multi-purpose injection molded vial for use in multiple applications including filling, sealing, storage and delivery of various fluid products, in particular the dosage of medical and pharmaceutical fluid products.

### BACKGROUND OF THE INVENTION

FIGS. 1-3 illustrate various prior art devices used in the medical and pharmaceutical fields, each comprising multiple components and configured for a single purpose and illustrate the limited purpose and disadvantages of each.

FIG. 1 shows a multi-component pre-filled syringe 101 having a male luer lock tip. Its purpose is to release a controlled amount of product. This syringe can be connected within various other devices in the luer ecosystem such as needles, vial adapters, and various ports.

FIG. 2 shows a multi-device system 102 including a pipette being used to draw a liquid product from a glass container. The user then uses the pipette to administer the product in various applications.

FIG. 3 shows a strip 103 of blow molded vials each having a female luer lock fitting.

The disadvantages of the known prior art arrangements include:
Multiple components/multiple material designs are environmentally unsustainable.
Difficulties securing the connections between various components/devices.
Difficulties in accurately withdrawing the desired amount of liquid product (resulting in the presence of air bubbles or jetting drops).
Difficulties in dispensing the product with one hand.
Difficulties in manufacturing a strip of vials (limited to female luer design).

### SUMMARY OF THE INVENTION

The object of the present invention is to improve the known drawbacks of current luer fitting pipettes, syringes, and vials by providing a single component injection molded plastic vial with a male luer lock fitting neck that offers enhanced ergonomics and simplifies the administration of a fluid or liquid product.

By incorporating ergonomic design principles, the invention aims to optimize user comfort and ease of handling during product administration.

The vial can be sealed empty for use as a pipette, or the vial can be filled and sealed and used as a sterile liquid container for all applications within the luer ecosystem.

The dosage of the liquid product from the vial is not limited to other luer devices and can be used for all applications that require precise dosing, such as a dropper.

The vial can also be used empty as a pump to withdraw a liquid product and release it later.

### Embodiment A

According to one embodiment of the invention, an article is provided (for example as shown in FIGS. 4A-4C, 5A-5C, 6, 7, 8A-8C, 9A-9C, 10A-10E, 11A-11F) comprising a dual-purpose vial that can function as one or both of a suction pump (e.g., to withdraw a fluid or liquid product from a container) and a dispensing device (e.g., as a dropper to dispense controlled amounts of a fluid or liquid product). The article may be manufactured as a strip of such articles, and the article may also be used as a container for a fluid or liquid product.

According to one such embodiment there is provided a dual-purpose integral injection molded plastic vial 15 having a squeezable body portion 8 with an internal chamber 9 and an integral neck portion 10 with a male luer lock fitting connector 16 for introducing and dispensing a fluid or liquid product FP to and from the internal chamber,
the neck portion 10 having an inner radial cone member 11 open at both ends and an outer bushing 2 radially spaced from the inner cone member, the outer bushing having an internal thread 7 configured to engage an external thread on a female luer lock fitting FLF connection,
wherein the dual-purpose vial 15 is configured to function as:
   a. a suction pump to draw a fluid product FP into the internal chamber 9 via the cone member 11 by first squeezing on the body portion 8 and then releasing the body portion 8 to create suction in the chamber 9 that draws fluid product FP into the chamber 9 via the cone member 11; and
   b. a dispensing apparatus by then squeezing the body portion 8 to drop dose the fluid product FP from the internal chamber 9 of the vial 15 via the cone member 11.

In accordance with one embodiment, the dual-purpose vial 15 is injection molded from a plastic material that is recyclable in a single plastic recycle stream. In accordance with another embodiment, the squeezable body portion 8 is injection molded with an open end 3 for subsequent sealing of the open end to form the internal chamber 9. In accordance with one embodiment, the dual-purpose vial is further configured to function as a container by filling the squeezable body portion 8 with the fluid product FP via the open end 3 and then sealing the open end 3 for later dispensing of the fluid product FP via the cone member 11. In accordance with one embodiment, the dual-purpose vial is further provided with a removable closure on the cone member 11 to seal the fluid product in the internal chamber 9, and wherein removal of the closure enables dispensing of the fluid product from the cone member 11.

In accordance with various embodiments, the dual-purpose vial 15 is injection molded as a strip 14 of multiple such vials. In one embodiment, the squeezable body portion 8 of each vial 15 in the strip 14 is injection molded with an open end 3 for subsequent sealing of the open end to form the internal chamber 9. In one embodiment, the open ends 3 of the strip of vials can be simultaneously filled with the fluid product FP prior to sealing the open ends.

### Embodiment B

According to another embodiment of the invention, an article is provided (for example as shown in FIGS. 7, 8A-8C) comprising a dual-purpose vial that can function as one or both of a suction pump (e.g., to withdraw a fluid or liquid product from a container) and a dispensing device (e.g., as a dropper to dispense controlled amounts of a fluid or liquid product) and which includes a frangible closure member. The article may be manufactured as a strip of such articles, and the article may also be used as a container for a fluid or liquid product.

According to one such embodiment, the vial is injection molded with a closure member 17 for sealing one open end 6 of the cone, and the closure member includes a frangible connecting portion 11b for disconnecting the closure member 17 from the cone 11 to open the one end 6 of the cone. According to one embodiment, the vial is filled by filling the squeezable body portion 8 with the fluid product FP via the open end 3, and the open end 3 is then sealed for later dispensing of the fluid product FP via the cone member 11. (FIGS. 7, 8A-8C)

### Embodiment C

According to another embodiment of the invention, an article is provided (for example as shown in FIGS. 9A-9C, 10A-10E, 11A-11F) comprising a dual-purpose vial that can function as one or both of a suction pump (e.g., to withdraw a fluid or liquid product from a container) and a dispensing device (e.g., as a dropper to dispense controlled amounts of a fluid or liquid product) and which includes a separate closure member or cap. The article may be manufactured as a strip of such articles, and the article may also be used as a container for a fluid or liquid product.

According to one such embodiment, the dual-purpose vial is provided in combination with a separate closure member 21, 31, 40 having a threaded connector for sealing the one open end of the cone member 11.

According to one embodiment, the cone member 11 has an inner frangible membrane 34 for sealing the internal chamber 9 prior to breaking the frangible membrane and unsealing the internal chamber after breaking the frangible membrane.

According to one such embodiment, the cone member 11 has an inner frangible membrane 34 for sealing the internal chamber 9 prior to breaking the frangible membrane and unsealing the internal chamber after breaking the frangible membrane, and the separate closure member 31 has a threaded connector FLF at one end for releasably engaging with the inner thread 7 of the bushing 2 and a puncture element 32 at another end for breaking the inner frangible membrane of the cone member (see e.g., FIGS. 10A-10E).

According to one such embodiment, the cone member 11 has an inner frangible membrane 34 for sealing the internal chamber 9 prior to breaking the frangible membrane and unsealing the internal, and the separate closure member 40 has a deformable portion 41 and a rigid portion 42 wherein the rigid portion can be compressed onto the deformable portion to break the inner frangible membrane 34 of the cone member (see e.g., FIG. 11A-11F).

According to one such embodiment, the vial is filled by filling the squeezable body portion 8 with the fluid product FP via the open end 3, and the open end 3 is then sealed for later dispensing of the fluid product FP via the cone member 11 (see e.g., FIGS. 9A-9C, 10A-10E, 11A-11F).

### Embodiment D

According to another embodiment of the invention, a method is provided for making an article is (for example as shown in FIGS. 12A-12D, 13A-13E and FIGS. 4A-4C, 5A-5C, 6, 7, 8A-8C, 9A-9C, 10A-10E, 11A-11F) comprising a dual-purpose vial that can function as one or both of a suction pump (e.g., to withdraw a fluid or liquid product from a container) and a dispensing device (e.g., as a dropper to dispense controlled amounts of a fluid or liquid product). The article may be manufactured as a strip of such articles, and the article may also be used as a container for a fluid or liquid product.

According to one such method embodiment, the method of making the vial includes steps of:
a) providing an injection molding apparatus including a mold comprising a pair of outer mold cavities and a pair of first and second mold cores, a linear rack for rotational translation of the first mold core to release the first mold core from the molded male luer lock fitting on the molded vial, and an ejector for removing the molded vial from one or more of the opened mold cavities,
b) injection molding the vial between the outer mold cavities and the cores, the male luer lock fitting being molded over the first mold core and the internal chamber being molded over the second mold core,
c) moving the linear rack to generate rotational translation of the first mold core to release the male luer lock fitting on the molded vial from the first mold core,
d) moving one or more of the outer mold cavities and the ejector to open the mold and to release the molded vial from one or more of the outer mold cavities, and
e) removing the second core from the molded internal chamber,

According to one such method embodiment, the method of making the vial includes steps of:
the molding apparatus further includes a stripper plate positioned to close one end of the mold between the pair of outer mold cavities, and the method step e) includes moving the stripper plate to remove the second core from the molded internal chamber of the molded vial.

### Embodiment E

According to another embodiment of the invention, a method is provided for filling and sealing an article (for example as shown in FIGS. 14A-14F and FIGS. 4A-4C, 5A-5C, 6, 7, 8A-8C, 9A-9C, 10A-10E, 11A-11F) comprising a dual-purpose vial that can function as one or both of a suction pump (e.g., to withdraw a fluid or liquid product from a container) and a dispensing device (e.g., as a dropper to dispense controlled amounts of a fluid or liquid product). The article may be manufactured as a strip of such articles, and the article may also be used as a container for a fluid or liquid product.

According to one such method embodiment, the method of filling and sealing the vial includes steps of:
a) filling the squeezable body portion 8 by introducing the fluid product FP into the open end 3,
b) sealing the open end 3 to form the internal chamber 9,
   wherein the filled and sealed vial provides a sealed container of the fluid product FP.

### BRIEF DESCRIPTION OF THE DRAWINGS

FIGS. 1-3 illustrate various prior art luer lock systems used in the medical and pharmaceutical fields, each comprising multiple components and configured for a single purpose; FIG. 1 shows a pre-filled syringe with an attached male luer lock tip; FIGS. 2 shows a pipette with a male luer lock tip; and FIG. 3 shows a strip of blow molded vials having female luer lock tips.

FIGS. 4A-4C illustrates one embodiment of an integral injection molded vial having a squeezable body portion and a neck with an integral male luer lock fitting according to the invention; FIG. 4A shows the vial with an integral neck and male luer lock fitting at one (upper) end and a squeezable body portion at the other (lower) end prior to sealing of the lower end; FIG. 4B shows the vial of FIG. 4A with the lower end now sealed to form a closed squeezable body portion having an internal chamber; FIG. 4C is an exploded view of an upper portion of the vial of FIGS. 4A-4B, showing in cross section the neck having a bushing with an inner thread that is spaced from and radially surrounding a central cone within the male lock luer fitting.

FIGS. 5A-5C illustrates one embodiment of a single component vial configured for multiple purposes according to the invention; FIG. 5A shows an integral injection molded vial (such as that shown in FIGS. 4A-4C) having a squeezable body portion and a neck with an integral male luer lock fitting; FIG. 5B shows the vial (of FIG. 5A) configured to act as a suction pump to draw a liquid product into the squeezable body potion from a container that is attached to the male luer lock fitting of the vial; FIG. 5C shows the vial (of FIGS. 5A-5B) subsequently being used as a drop dispenser for precise dispensing of the liquid product from the squeezable body via the neck of the vial.

FIG. 6 illustrates one embodiment of an integral injection molded vial according to the invention having a squeezable body portion and a neck with an integral male luer lock fitting connector, wherein a plurality of such vials is injection molded as a strip with frangible (breakable) connecting portions enabling separation of the individual vails.

FIG. 7 illustrates one embodiment of an integral injection molded vial according to the invention having a squeezable body portion and a neck with an integral male luer lock fitting connector, also injection molded as a strip, but differing from the vials of FIG. 6 in having an integral closure member at the upper end of each vial with a frangible (breakable) portion for removing the closure member (for filling and/or dispensing).

FIGS. 8A-8C illustrates one embodiment of the structure and multi-purpose use of the vial of FIG. 7; FIG. 8A shows a partial view in cross section of the upper end of the vial as injection molded with the integral closure member the upper end; FIG. 8B is a view similar to FIG. 8A but showing the frangible portion being broken to remove the closure member; and FIG. 8C shows the entire vial of FIGS. 8A-8B which is filled with a liquid product in the squeezable body portion and prior to removal of the frangible closure member thus providing a sterile closed environment for the liquid product.

FIGS. 9A-9C illustrates one embodiment of the structure and multi-purpose use of the vial of FIG. 6; FIG. 9A shows a separate closure cap having a female luer lock fitting prior to connecting to the upper end of the vial; FIG. 9B is a view similar to FIG. 9A but showing the closure cap now connected in a secure leak proof manner by the female luer fitting on the cap connected to the male luer fitting on the vial; and FIG. 9C shows a strip of the injection molded vials of FIGS. 9A-9B, each with an attached closure cap, wherein the strip of vials can be filled simultaneously by introducing liquid product into the body portion via the open lower end of each vial simultaneously, followed by sealing of the lower ends of all vials simultaneously, thus providing a sterile closed environment for the liquid product in each vial.

FIGS. 10A-10E illustrates one embodiment of the structure and multi-purpose use of a vial according to the invention similar to that of FIG. 6, but now including a frangible membrane in the cone of the male luer lock fitting for sealing the liquid product in the vial prior to use; FIG. 10A shows a separate closure cap having a female luer lock fitting at one (lower) end prior to connecting to the male luer lock fitting at the upper end of the vial, and the closure cap having a projection for breaking the frangible membrane in the cone of the male luer lock fitting prior to use; FIG. 10B is a view similar to FIG. 10A but showing the closure cap now connected in a secure leak proof manner by the female luer fitting on the cap connected to the male luer fitting on the vial; and FIGS. 10C-10E show in cross section a method of use of the vial of FIGS. 10A-10B, wherein FIG. 10C illustrates removal of the closure cap from the neck of the vial, FIG. 10D illustrates breaking the frangible membrane by the projection on the cap being inserted into the upper end of the cone and pushing down on the cap/projection to cause the projection to engage and puncture the membrane, and FIG. 10E illustrates the neck of the vial after the membrane has been punctured, thus allowing subsequent controlled drop dosing of the liquid product from the male luer lock fitting at the upper end of the vial.

FIGS. 11A-11F illustrates one embodiment of the structure and multi-purpose use of a vial according to the invention similar to that of FIGS. 10A-10E, having a frangible membrane in the cone of the male luer lock fitting for sealing the liquid product in the vial prior to use, shown with another embodiment of a separate closure cap having two separate components; FIG. 11A shows a two-component closure cap including a lower deformable cap having a female luer lock fitting at one (lower) end prior to connecting to the male luer lock fitting at the upper end of the vial, and the closure cap having a separate rigid projection component for breaking the frangible membrane in the cone of the male luer lock fitting prior to use; FIG. 11B is a view similar to FIG. 11A but showing the projection component now detached from the lower cap; FIG. 11C shows the combined 2 component closure cap now connected in a secure leak proof manner by the female luer fitting on the cap to the male luer fitting on the vial; and FIGS. 11D-11F show in cross section a method of use of the vial and two-component closure cap, wherein FIG. 11D illustrates the closure cap attached to the neck of the vial, FIG. 11E illustrates breaking the frangible membrane by pushing down on the projection component to compress/deform the lower cap and thereby inserting the projection into the upper end of the cone to engage and puncture the membrane, and FIG. 11F illustrates the neck of the vial after the membrane has been punctured, thus allowing subsequent controlled drop dosing of the liquid product from the male luer lock fitting at the upper end of the vial.

FIGS. 12A-12D illustrates one embodiment of a method of making the injection molded vial of the invention, wherein FIGS. 12A-12D show a series of steps and an injection molding apparatus including a linear rack to enable removal of the integrally molded male luer lock fitting on the neck of the vial, from the mold after injection molding; FIG. 12A shows a closed injection mold (in which the vial is molded); FIG. 12B shows rotation of the rack to enable release of the male luer lock fitting on the molded vial; FIG. 12C shows the mold after opening, and FIG. 12D shows the final removal of the vial from the mold via use of a stripper plate.

FIGS. 13A-13E illustrates another embodiment of a method of making the injection molded vial of the invention, similar to the FIGS. 12A-12D embodiment, but without the stripper plate; FIGS. 13A-13E show a series of method steps and the injection molding apparatus.

FIGS. 14A-14F illustrates another embodiment of a method of filling and sealing the injection molded vial of the invention.

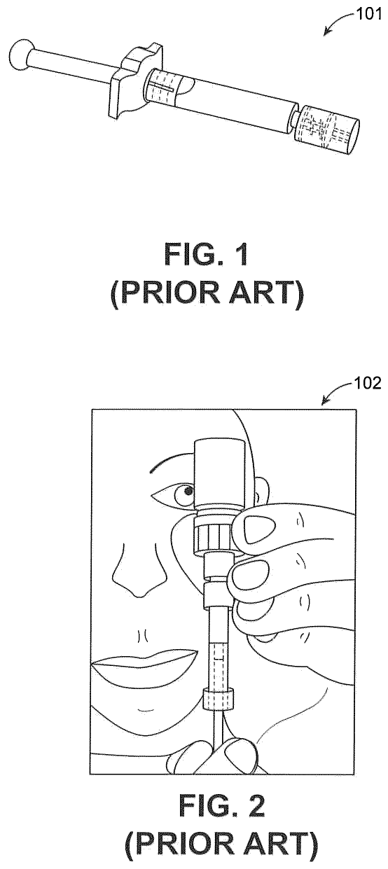

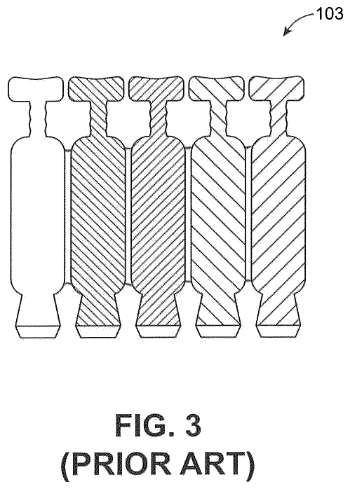

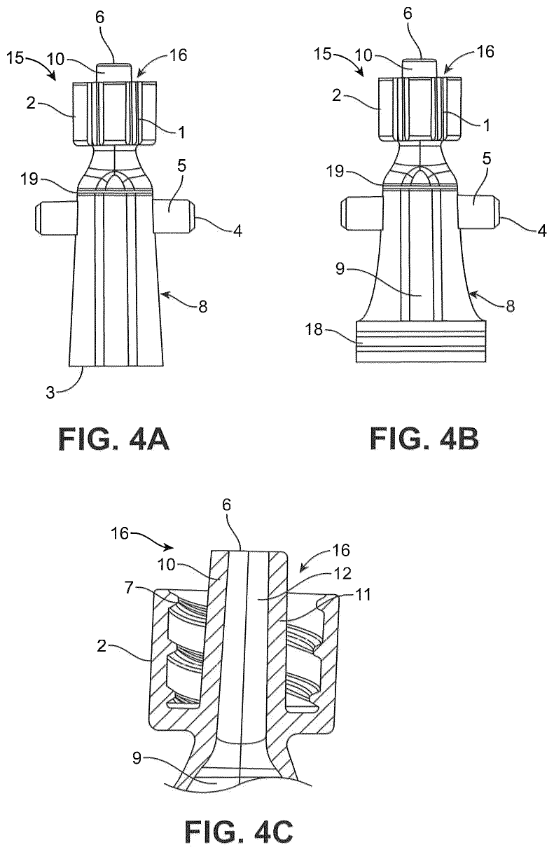

### DETAILED DESCRIPTION

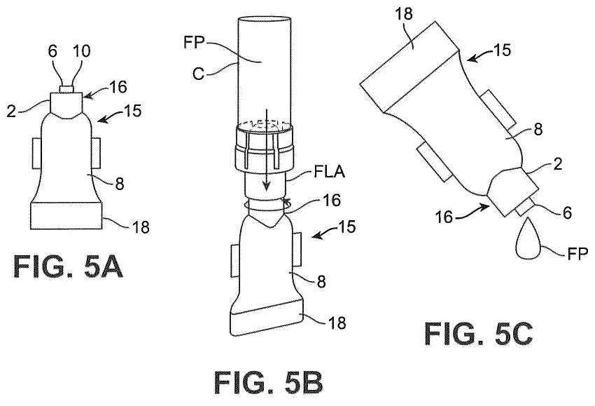

### Purpose and Features of Various Embodiments of the Invention as Shown in FIGS. 4A-4C, 5A-5C, 6, 7, 8A-8C, 9A-9C, 10A-10E, 11A-11F, 12A-12D, 13A-13E, 14A-14F

The object of the present invention is to improve the known drawbacks of current luer fitting pipettes, syringes, and vials by providing a single component injection molded plastic vial with a male luer lock fitting neck that offers enhanced ergonomics and simplifies the administration of a fluid or liquid product.

By incorporating ergonomic design principles, the invention aims to optimize user comfort and ease of handling during product administration.

The vial can be sealed empty for use as a pipette, or the vial can be filled and sealed and used as a sterile liquid container for all applications within the luer ecosystem.

The dosage of the liquid product from the vial is not limited to other luer devices and can be used for all applications that require precise dosing, such as a dropper.

The vial can also be used empty as a pump to withdraw a liquid product and release it later.

### Embodiment of FIGS. 4A-4C

FIGS. 4A-4C illustrates one embodiment of an integral injection molded plastic vial 15 having a squeezable body portion 8 at one (lower) end 3 and an integral neck portion 10 with a male luer lock fitting 16 at the other (upper) end 6. FIG. 4A shows the vial as a single injection molded component with the lower end 3 open (prior to sealing). FIG. 4B shows the vial 15 with the lower end now sealed 18 (e.g., by application of heat and pressure to seal together opposing walls of the body portion) to form the closed squeezable body portion having an internal chamber 9 configured to hold the fluid product. FIG. 4C is an exploded view of the upper neck portion 10 showing in cross section the neck 10 having a cylindrical bushing 2 with inner thread 7 spaced from and radially surrounding a central cone 11 to from the male luer lock fitting 16. The cone has an open central fluid passage 12 that is open at the top end 6 of the neck (for receiving and delivery of fluid into and from the internal chamber 9) and open at the lower end (for delivery to and receiving fluid from the internal chamber 9).

In its sealed (at lower end 18) empty configuration (shown in FIG. 4B), the vial 15 can be used as a dual-purpose device, serving both as a suction pipette for aspirating a fluid product (by squeezing and then releasing the squeezable body portion to create an interior vacuum that pulls the fluid product into the internal chamber 9 via the opening at the top end 6 of the neck), and as a precision dosing tool (by controlled squeezing of the filled squeezable body portion 8 to deliver the fluid product out the open top end 6 of the neck) for subsequent administration.

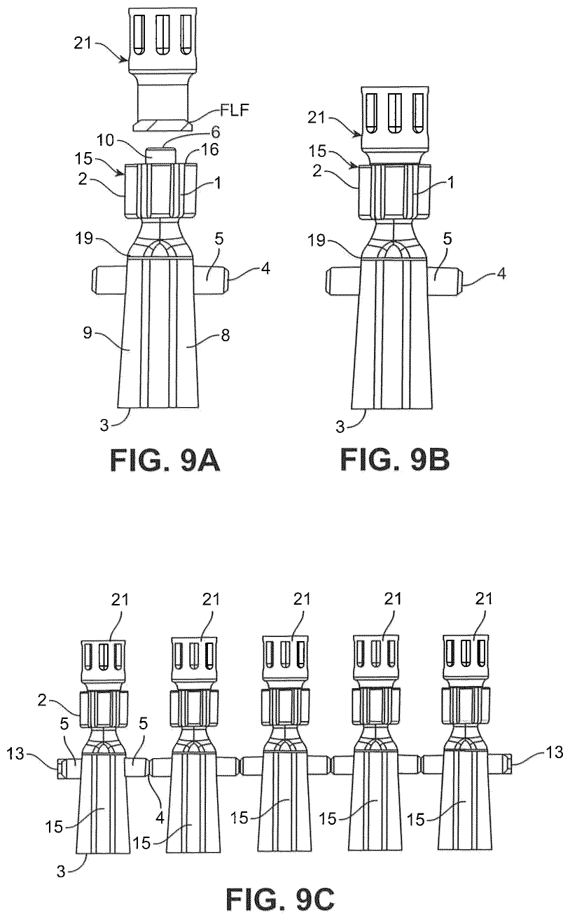

The plastic vial can also be filled with a fluid product, sealed at both top and bottom ends (as described hereinafter with reference to FIGS. 7, 8A-8C, 9A-9C, 10A-10E, 11A-11F), and utilized as a sterile container for substances, enhancing its versatility as a versatile multipurpose apparatus.

The vial 15 is made of an injection moldable plastic (such as polypropylene PP, low density polyethylene LDPE, high density polyethylene HDPE, cyclic olefin copolymer COC, polystyrene PS, etc.) and comprises the least partly squeezable lower hollow body portion 8, the upper neck portion 10 with a male luer lock fitting 16, and at least two openings, one at the top end 6 and the other at the lower end 3.

The vial 15 comprises a luer lock fitting connector 16 in the neck of the vial, comprising a luer cone 11 and a luer bushing 2 having an internal thread 7 that allows the screwing of a female luer connection.

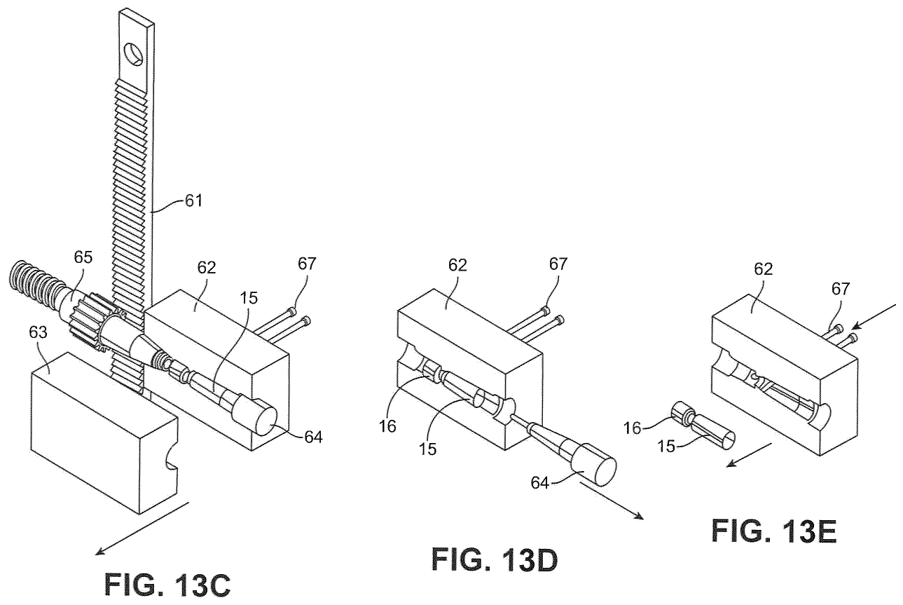

The vial 15 may further (optionally) comprises a series of grip lines 1 to improve grip during use. These lines are also useful during injection process to facilitate unscrewing of the mold core 65 (as shown in FIGS. 12A-12D) allowing the bushing 2 to remain secure in the mold cavities 62-63.

The vial 15 may further optionally comprises at least one marked, labeled or reference part 19 which serves as a reference re fluid product filling and delivery during use. This reference part 19 can be placed at any height along the length of the vial body portion 8.

The vial comprises at least one lower edge 3 that is adapted to be sealed, by pressing the edge itself to define a sealed lower edge portion 18.

Once the vial 15 is sealed at the lower end, a chamber 9 is formed, and that chamber performs the function of a pump, sucking product from the orifice 6 located at the top of the vial.

The vial 15 can be injection molded as a single vial 15 or as a strip 14 comprising a plurality of vials 15. The vials 15 of the strip are each provided with at least one spacer element 5, preferably substantially plate shaped and on opposing sides of the body portion 8, and with at least one frangible attachment area 4 for breaking off the spacer elements 5 between each vial.

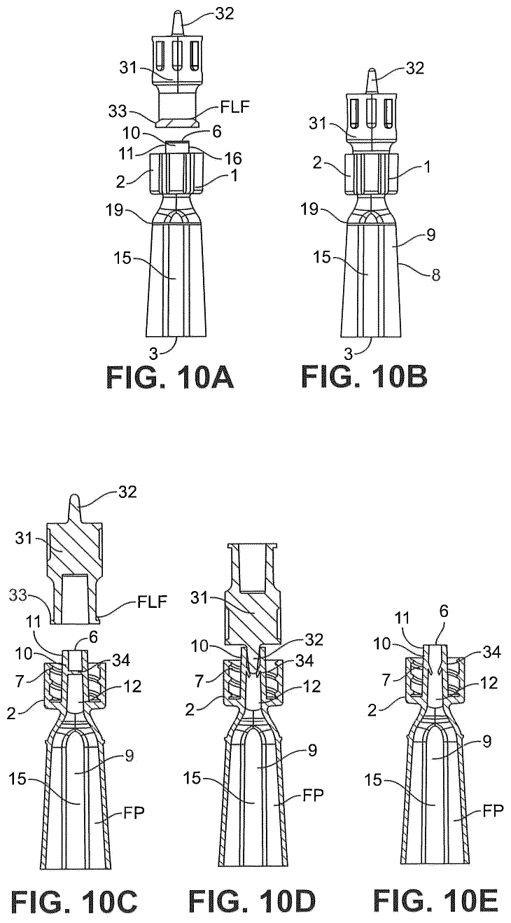

In a variation shown in FIGS. 7 and 8A-8C the vial 15 comprises at least one closure element 17 molded integral with the hollow cone 11 along at least one predefined breaking line 11b adapted to allow the separation of the closure element 17 from the hollow cone 11. In this variation, the vial can be filled with a fluid product (liquid, cream) via the open bottom end 3 before being sealed at 18.

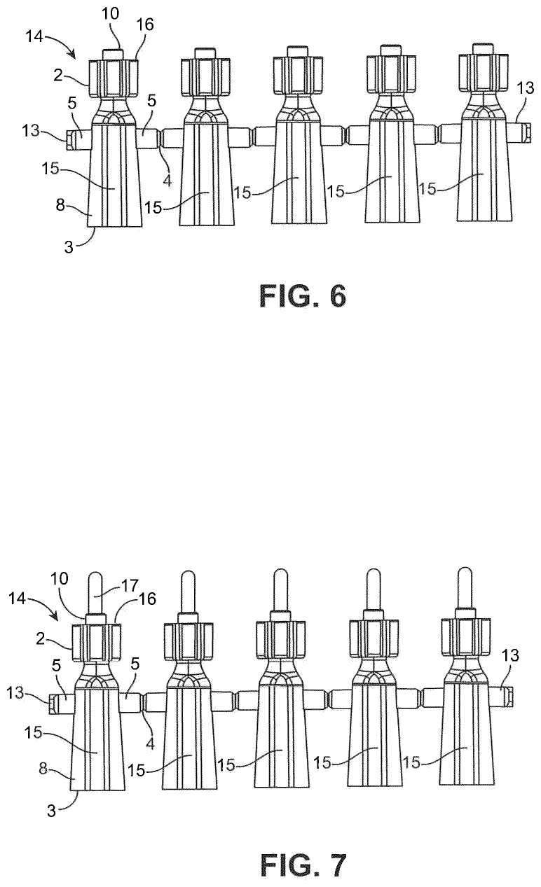

### Usage Example of the Present Invention (FIGS. 5A-5C)

In one example, illustrated in FIGS. 5A-5C, the vial is used as a pipette to withdraw a fluid product from a glass container and then to dose the same fluid product in various applications.

FIGS. 5A-5C illustrates one embodiment of the present invention and use of a single. component vial configured for multiple purposes. FIG. 5A shows an integral injection molded vial 15 (such as that shown in FIG. 4) having a squeezable body portion 8 and a neck 10 with an integral male luer lock fitting 16. FIG. 5B shows the vial 15 configured to act as a suction pump to draw a liquid product into the squeezable body potion 8 from a container C that is attached to the male luer lock fitting 16 of the vial. FIG. 5C shows the vial 15 subsequently being used as a drop dispenser for precise dispensing of the liquid product from the squeezable body 8 via the neck 10 of the vial.

In FIG. 5B the vial 15 is shown being attached to a glass container C via a female luer adapter FLA on the lower end of the container C (that is pushed down and rotated, see arrows) to connect the FLA to the male luer lock fitting 16 in a fluid tight manner. Fluid product FP is then drawn from the glass container using the vial 15 as a pump; the vial is then disconnected from the container (by disconnecting the male luer lock 16 on the vial from the FLA on the container C) and the vial can then be used to dose the fluid product FP in controlled drops as shown in FIG. 5C

One advantage over known pipette devices is in the intuitiveness and ease of use.

Another advantage over known prior art is in the production of the vial (and/or vial strip) with male luer lock fitting in an injection molding technology. Injection molding technology produces a more accurately dimensioned vial and luer lock fitting, and one having fewer defects than technologies such as “blow, fill and seal” and/or Seal and/or “blow molding”.

Another advantage is that prior known pipettes are often composed of multiple components; in contrast the invention provides a one-piece integral vial which is more sustainable/recyclable in a single plastic recycling stream.

Another advantage is that the present vial can be integrated into the whole luer ecosystem and can be used in different application fields such as: medicinal, cosmetic, nutraceutical, rapid test, laboratory, etc.

Another advantage is the ability to fill the vial or strip of vials using Pentafill filling machines.

In various embodiments, the following features are advantages of the present invention:
Vial with a male luer fitting connector integrated, made in injection molding technology.
The use as a pipette for a vial with a male luer lock fitting connector
The sealing of an empty male luer lock fitting vial
Producing a strip of multiple vials with male luer lock fitting integrated.
A closed male luer lock fitting connector made in injection molding technology.
Integrating this closed, single-piece male luer lock fitting connector inside other products such as syringes or other apparatus made in injection molding technology.
A vial or strip of multiple vials with a closed male luer fitting connector integrated, made in injection molding technology.
The ergonomics of the vial
Drop dosing with a male luer lock fitting vial.

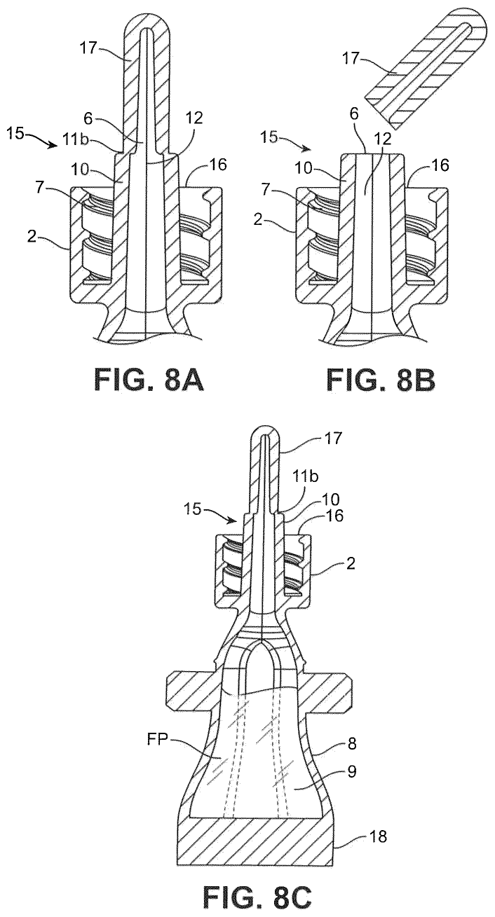

### Embodiments of FIGS. 6, 7, 8A-8C

FIG. 6 illustrates one embodiment of an integral injection molded vial 15 having a squeezable body portion 8 and a neck 10 with an integral male luer lock fitting 16, wherein a plurality of such vials is injection molded as a strip 14 with frangible (breakable) connecting portions 5/4 enabling separation of the individual vails 15.

FIG. 7 illustrates one embodiment of an integral injection molded vial 15 having a squeezable body portion 8 and a neck 10 with an integral male luer lock fitting 16, also injection molded as a strip 14, but differing from the vials of FIG. 6 in having an integral closure member 17 at the upper end of each vial with a frangible (breakable) portion 11b for removing the closure member 17 (for filling and/or dispensing via the top opening 6 formed by breaking off the closure member 17).

FIGS. 8A-8C illustrates one embodiment of the structure and multi-purpose use of the vial 15 of FIG. 7. FIG. 8A shows a partial view in cross section of the upper neck end 10 of the vial as injection blow molded with the integral closure member 17 at the upper end. FIG. 8B is a view similar to FIG. 8A but showing the frangible portion 11b being broken to remove the closure member 17. FIG. 8C shows the entire vial of FIGS. 8A-8B which is filled with a fluid product FP product in the internal chamber 9 of the squeezable body portion 8 and prior to removal of the frangible closure member 17 thus providing a sterile closed environment for the fluid product.

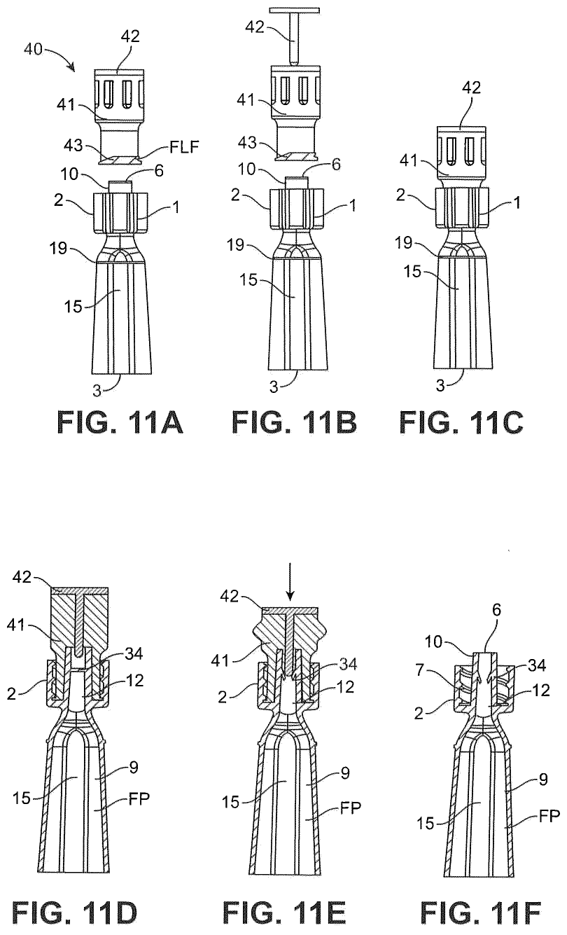

### Embodiment of FIGS. 9A-9C

FIGS. 9A-9C illustrates one embodiment of the structure and multi-purpose use of the vial 15 of FIG. 6 for use with a separate closure cap 21. FIG. 9A shows a separate closure cap 21 having a female luer lock fitting FLF at the lower end prior to connecting to the male luer lock fitting 16 at the upper neck end 10 of the vial 15. FIG. 9B is a view similar to FIG. 9A but showing the closure cap 21 now connected in a secure leak proof manner by the female luer fitting FLF on the cap 21 connected to the male luer fitting 16 on the vial. FIG. 9C shows a strip 14 of the injection molded vials 15 of FIGS. 9A-9B, each with an attached closure cap 21, wherein the strip of vials can be filled simultaneously by introducing liquid product into the body portion 8 via the open lower end 3 of each vial 15 simultaneously, followed by sealing of the lower ends 3 of all vials simultaneously, thus providing a sterile closed environment for the liquid product in each vial.

The closure cap 21 may also be made of plastic (such as Bromobutyl BIIR, PP, LDPE, HDPE, COC, PS, etc.) or other materials, and may comprise a single component or a plurality of components. The cap 21 can be screwed into the bushing 2 because it has a female luer lock fitting FLF that is compatible with the male luer thread 7 on the male luer lock fitting 16 on the vial.

In one variant the vial 15 can be filled with a product (liquid, cream) after capping it and before being sealed at the lower end 3.

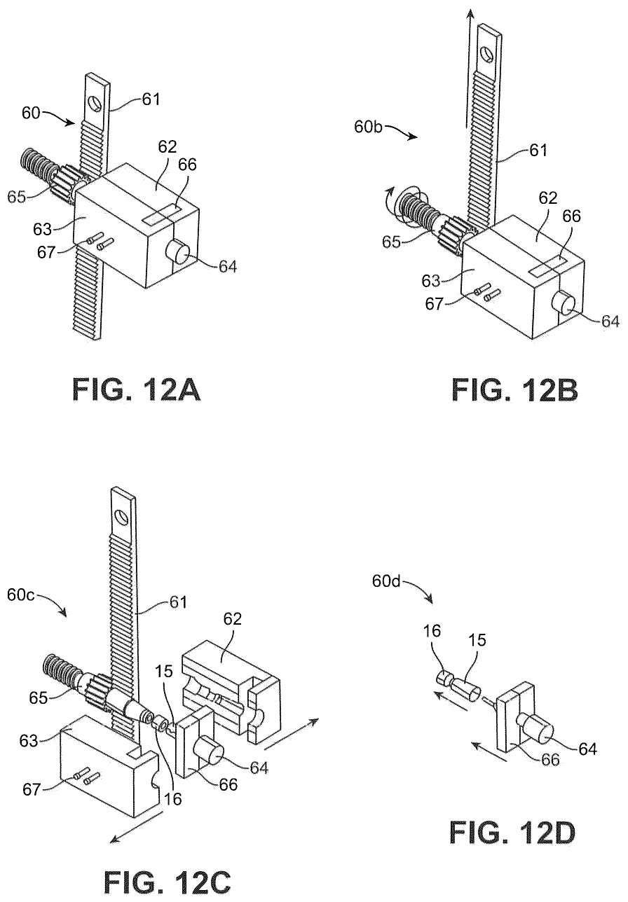

### Embodiment of FIGS. 10A-10E

FIGS. 10A-10E illustrates one embodiment of the structure and multi-purpose use of a vial 15 similar to that of FIG. 6, but now including a frangible membrane 34 in the central passage 12 of the cone 11 of the male luer lock fitting 16 for sealing the fluid product FP in the vial prior to use. FIG. 10A shows a separate closure cap 31 having a female luer lock fitting FLF at one (lower) end prior to connecting to the male luer lock fitting 16 at the upper end of the vial 15. The closure cap 31 has a projection 32 for breaking the frangible membrane 34 in the cone 11 of the male luer lock fitting 16 prior to use. FIG. 10B is a view similar to FIG. 10A but showing the closure cap 31 now connected in a secure leak proof manner by the female luer lock fitting FLF on the cap connected to the male luer lock fitting 16 on the vial. FIGS. 10C-10E show in cross section a method of use of the vial 15 of FIGS. 10A-10B, wherein FIG. 10C illustrates removal of the closure cap 31 from the neck 10 of the vial, FIG. 10D illustrates breaking the frangible membrane 34 by the projection 32 on the cap being inserted into the upper end of the cone 11 and pushing down on the cap/projection 31/32 to cause the projection 32 to engage and puncture the membrane 34, and FIG. 10E illustrates the neck 10 of the vial after the membrane 34 has been punctured, thus allowing subsequent controlled drop dosing of the fluid product FP from the opening 6 of the male luer lock fitting 16 at the upper end of the vial.

In the variation shown in FIGS. 10A-10E the vial 15 comprises at least an inner membrane 34 inside the luer cone 11 to create a closed internal chamber 9 once the vial is sealed.

The cap 31 has a female luer fitting FLF has a female thread 33 to allow screwing into the internal thread 7 on the bushing 22 of the male luer lock fitting 16 on the vial.

The cap 31 can be made of plastic (such as Bromobutyl BIIR, PP, LDPE, HDPE, COC, PS, etc.) or other materials, and may compromise a single component or a plurality of components.

The cap 31 includes a projection or pin 32 that can be used to open the vial 15 by piercing the membrane 34 as shown in the FIGS. 10A-10E. Once the membrane is broken, the fluid product FP inside the vial can be dispensed.

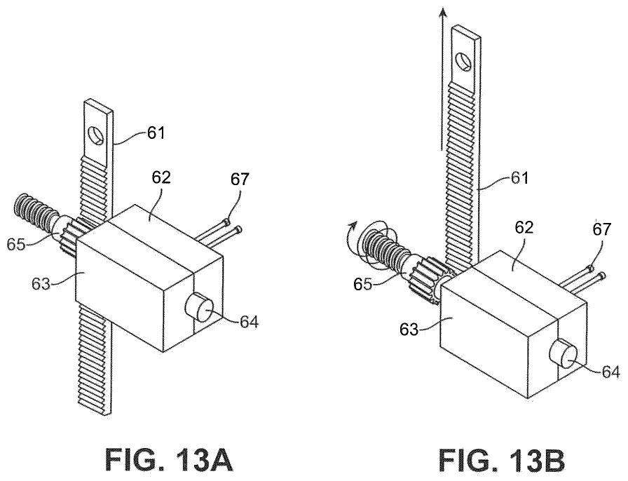

### Embodiment of FIGS. 11A-11F

FIGS. 11A-11F illustrates one embodiment of the structure and multi-purpose use of a vial 15 similar to that of FIGS. 10A-10E, also having a frangible membrane 34 in the cone 11 of the male luer lock fitting 16 for sealing the fluid product FP in the vial prior to use. FIGS. 11A-11F shows another embodiment of a separate closure cap 40 having two separate components 41 and 42. FIG. 11A shows the two-component closure cap 40 including a lower deformable cap component 41 having a female luer lock fitting FLF at one (lower) end prior to connecting to the male luer lock fitting 16 at the upper end of the vial 15. The closure cap 40 also has a separate rigid projection component 42 for breaking the frangible membrane 34 in the cone 11 of the male luer lock fitting prior to use. FIG. 11B is a view similar to FIG. 11A but showing the projection component 42 now detached from the lower cap 41. FIG. 11C shows the combined two component closure cap 41, 42 now connected in a secure leak proof manner by the female luer fitting FLF on the cap 41 to the male luer fitting 16 on the vial. FIGS. 11D-11F show in cross section a method of use of the vial 15 and two-component closure cap 41,42, wherein FIG. 11D illustrates the combined closure cap 40 attached to the neck of the vial, FIG. 11E illustrates breaking the frangible membrane 34 by pushing down on the projection component 42 to compress/deform the lower cap 41 and thereby inserting the projection 42 into the upper end of the cone 11 to engage and puncture the membrane 34, and FIG. 10F illustrates the neck 10 of the vial after the membrane 34 has been punctured, thus allowing subsequent controlled drop dosing of the fluid product FP from the opening 6 at the top end of the male luer lock fitting 16 at the upper end of the vial.

In the variation shown in FIGS. 11A-11F the vial 15 includes at least an inner membrane 34 inside the luer cone 11 to create a closed chamber 9 once the vial is sealed.

The cap can be made by two plastic (such as Bromobutyl BIIR, PP, LDPE, HDPE, COC, PS, etc. or other materials) components 41,42 connected to each other. The component 41 is designed to be deformable under compression while component 42 is designed to be rigid.

Once the cap is screwed into the vial (FIG. 11D), the projection component must be pushed won (see arrow) as shown in FIG. 11E to break the membrane 34.

### FIGS. 12A-12D Embodiment of a Molding Process and Apparatus

FIGS. 12A-12D illustrates one embodiment of a method of making the injection molded vial 15 of the invention. FIGS. 12A-12D show a series of steps and an injection molding apparatus including a linear rack 61 to enable removal of the integrally molded male luer lock fitting 16 on the neck 10 of the vial 15, from the mold cavities 62, 63 and mold cores 64, 65 after injection molding. FIG. 12A shows a closed injection mold (closed mold halves 64, 65 in which the vial 15 is molded). FIG. 12B shows rotation of the mold core 65 to enable release of the male luer lock fitting 16 of the molded vial 15. FIG. 12C shows opening of the mold cavities and use of the ejectors 67 to release the vial 15, and FIG. 12D shows the final removal of the vial from the mold via use of a stripper plate 66.

FIGS. 12A-12D illustrates one method of injection molding a vial 15 of the present invention, including use of the apparatus as defined by the following reference numbers:
61—linear rack
62—female cavity
63—female cavity
64—mold core
65—mold core
66—stripper plate
67—ejector

FIG. 12A shows the injection mold closed and ready for plastic injection.

FIG. 12B shows the mold after plastic injection, the linear rack 61 moves, generating a rotational/translation of the mold core 65. In this way the inner part of the bushing 2 of the vial 15 is released.

FIG. 12C shows the apparatus after unscrewing of the mold core 65, the two female cavities 62, 63 open. In this step the ejectors 67 move and help to detach the vial 15 from the cavity.

FIG. 12D shows the apparatus after removal from the mold, showing use of the stripper plate 66 to move and release the vial 15 from the mold core 64.

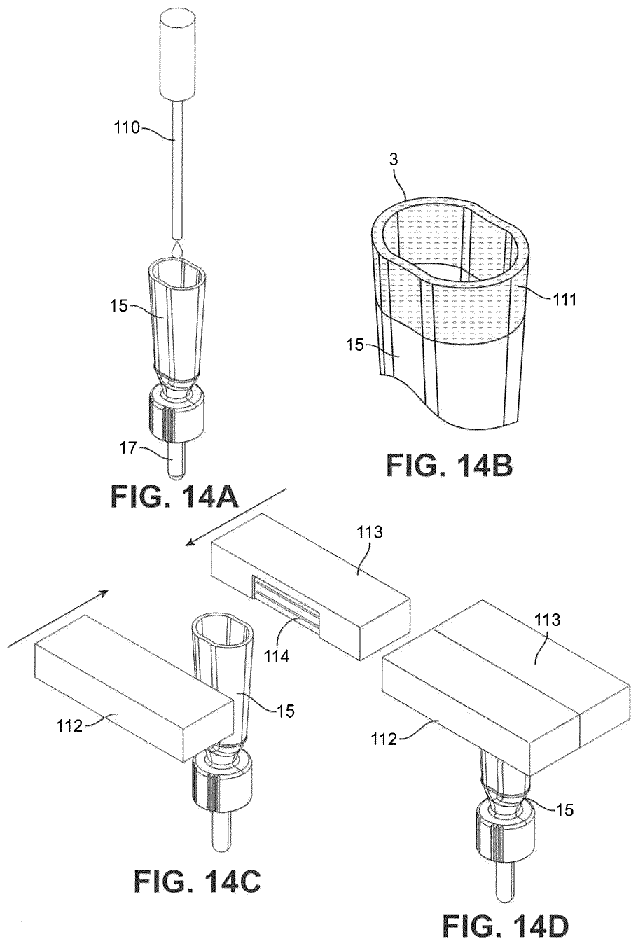

### FIGS. 13A-13E Alternative Embodiment of a Molding Process and Apparatus

FIGS. 13A-13E illustrates another embodiment of a method of making the injection molded vial 15, similar to FIGS. 12A-12D but without use of a stripper plate 66. The molding components have the same reference numbers as used in the FIGS. 12A-12D embodiment, namely:
61—linear rack
62—female cavity
63—female cavity
64—mold core
65—mold core
67—ejector

FIGS. 13A-13E show a series of steps and an injection molding apparatus including a linear rack 61 to enable removal of the integrally molded male luer lock fitting 16 on the neck 10 of the vial 15, from the mold cavities 62, 63 and mold cores 64, 65 after injection molding. FIG. 13A shows a closed injection mold (closed mold halves 62, 63 in which the vial 15 is molded). FIG. 13B shows rotation of the mold core 65 to enable release of the male luer lock fitting 16 of the molded vial 15. FIG. 13C shows opening of the mold cavities; in this variation only one of the female cavities moves 63. FIG. 13D shows the mold core 64 being removed from the vial 15, while the vial is still positioned in the mold cavity 62. FIG. 13E shows the use of the ejectors 67 to remove the vial 15 from the mold cavity 62.

FIG. 13A shows the injection mold closed and ready for plastic injection.

FIG. 13B shows the mold after plastic injection, the linear rack 61 moves, generating a rotational/translation of the mold core 65. In this way the inner part of the bushing 2 of the vial 15 is released.

FIG. 13C shows the apparatus after unscrewing of the mold core 65, the female cavity 63 opens and the other mold cavity 62 remains in position.

FIG. 13D shows the mold core 64 removal from the vial 15.

FIG. 13E shows the ejectors 67 move and help to detach the vial 15 from the mold cavity 62.

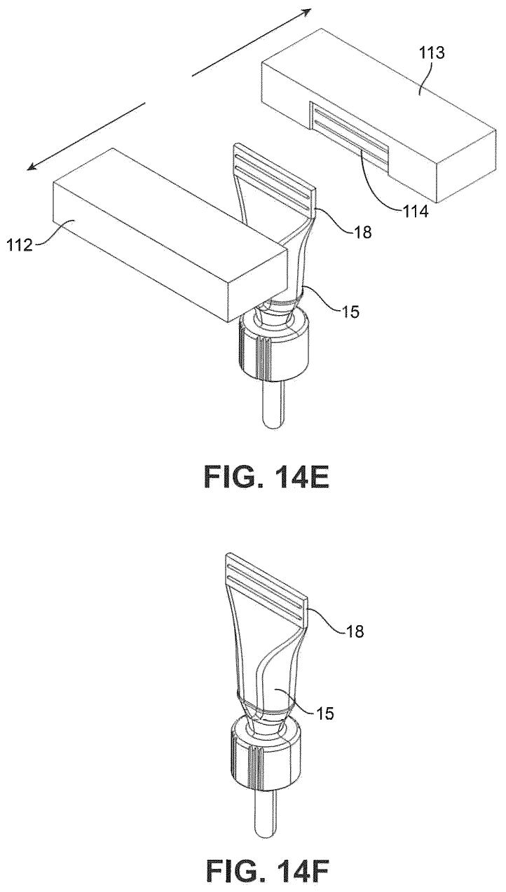

### FIGS. 14A-14F Embodiment of a Method of Filling and Sealing

FIGS. 14A-14F illustrates one embodiment of the invention for filling and sealing a vial wherein:

FIG. 14A shows the step of filling the open ended body portion 8 of vial 15 with liquid product via filling needle 110;

FIG. 14B shows the subsequent step, after filling, of heating end portion 111 of the body 8, adjacent the open end 3;

FIGS. 14C-14D show the subsequent step, after heating, of sealing the end 3 of filled body portion by squeezing together (between two cold clamps 112, 113, with ribs 114) the heated end portion 111 to form a sealed end 18;

FIGS. 14E-14F show the subsequent step of opening the clamps 112, 113 to produce the filled and sealed vial with sealed end 18.

These and other alternative embodiments fall within the scope of the pending claims.

1. A dual-purpose integral injection molded plastic vial (15) having a squeezable body portion (8) with an internal chamber (9) and an integral neck portion (10) with a male luer lock fitting connector (16) for introducing and dispensing a fluid product FP to and from the internal chamber,
the neck portion (10) having an inner radial cone member (11) open at both ends and an outer bushing (2) radially spaced from the inner cone member, the outer bushing having an internal thread (7) configured to engage an external thread on a female luer lock fitting FLF connection,
wherein the dual-purpose vial (15) is configured to function as:
a. a suction pump to draw a fluid product FP into the internal chamber (9) via the cone member (11) by first squeezing on the body portion (8) and then releasing the body portion (8) to create suction in the chamber (9) that draws fluid product FP into the chamber (9) via the cone member (11); and
b. a dispensing apparatus by then squeezing the body portion (8) to drop dose the fluid product FP from the internal chamber (9) of the vial (15) via the cone member (11).

2. The dual-purpose vial of claim 1, wherein the vial (15) is injection molded from a plastic material that is recyclable in a single plastic recycle stream.

3. The dual-purpose vial of claim 1, wherein the squeezable body portion (8) is injection molded with an open end (3) for subsequent sealing of the open end to form the internal chamber (9).

4. The dual-purpose vial of claim 3, wherein the vial is further configured to function as:
c. a container by filling the squeezable body portion (8) with the fluid product FP via the open end (3) and then sealing the open end (3) for later dispensing of the fluid product FP via the cone member (11).

5. The dual-purpose vial of claim 4, wherein the vial is further provided with a removable closure on the cone member (11) to seal the fluid product in the internal chamber (9), and wherein removal of the closure enables dispensing of the fluid product from the cone member (11).

6. The dual-purpose vial of claim 1, wherein the vial is injection molded as a strip (14) of multiple such vials.

7. The strip of dual-purpose vials of claim 6, wherein the squeezable body portion (8) of each vial (15) in the strip (14) is injection molded with an open end (3) for subsequent sealing of the open end to form the internal chamber (9).

8. The strip of dual-purpose vials of claim 7, wherein the open ends (3) of the strip of vials can be simultaneously filled with the fluid product FP prior to sealing the open ends.

9. The dual-purpose vial of claim 1, wherein the vial is injection molded with a closure member (17) for sealing one open end (6) of the cone, and the closure member includes a frangible connecting portion (11b) for disconnecting the closure member (17) from the cone (11) to open the one end (6) of the cone.

10. The dual-purpose vial of claim 9, wherein the vial is filled by filling the squeezable body portion (8) with the fluid product FP via the open end (3), and the open end (3) is then sealed for later dispensing of the fluid product FP via the cone member (11).

11. An apparatus comprising the dual-purpose vial of claim 1 in combination with a separate closure member (21), (31), (40) having a threaded connector for sealing the one open end (6) of the cone member (11).

12. The dual-purpose vial of claim 1, wherein the cone member (11) has an inner frangible membrane (34) for sealing the internal chamber (9) prior to breaking the frangible membrane and unsealing the internal chamber after breaking the frangible membrane.

13. The apparatus of claim 11, wherein the cone member (11) has an inner frangible membrane (34) for sealing the internal chamber (9) prior to breaking the frangible membrane and unsealing the internal chamber after breaking the frangible membrane, and the separate closure member (31) has a threaded connector FLF at one end for releasably engaging with the inner thread (7) of the bushing (2) and a puncture element (32) at another end for breaking the inner frangible membrane of the cone member.

14. The apparatus of claim 11, wherein the cone member (11) has an inner frangible membrane (34) for sealing the internal chamber (9) prior to breaking the frangible membrane and unsealing the internal, and the separate closure member (40) has a deformable portion (41) and a rigid portion (42) wherein the rigid portion can be compressed onto the deformable portion to break the inner frangible membrane (34) of the cone member.

15. The dual-purpose vial of claim 11, wherein the vial is filled by filling the squeezable body portion (8) with the fluid product FP via the open end (3), and the open end (3) is then sealed for later dispensing of the fluid product FP via the cone member (11).

16. A method of making the vial of claim 1, including steps of:
a) providing an injection molding apparatus including a mold comprising a pair of outer mold cavities (62), (63) and a pair of first and second mold cores (64), (65), a linear rack (61) for rotational translation of the first mold core (64) to release the first mold core from the molded male luer lock fitting (16) on the molded vial (15), and an ejector (67) for removing the molded vial (15) from one or more of the opened mold cavities,
b) injection molding the vial (15) between the outer mold cavities and the cores, the male luer lock fitting (16) being molded over the first mold core (64) and the internal chamber (9) being molded over the second mold core (65),
c) moving the linear rack (61) to generate rotational translation of the first mold core (64) to release the male luer lock fitting (16) on the molded vial from the first mold core,
d) moving one or more of the outer mold cavities (62), (63) and the ejector (67) to open the mold and to release the molded vial (15) from one or more of the outer mold cavities, and
e) removing the second core (65) from the molded internal chamber (9).

17. The method of claim 16, wherein the molding apparatus further includes a stripper plate (66) positioned to close one end of the mold between the pair of outer mold cavities (62), (63), and the method step e) includes moving the stripper plate to remove the second core (65) from the molded internal chamber (9) of the molded vial (15).

18. A method of filling and sealing the vial of claim 3, comprising:
a) filling the squeezable body portion (8) by introducing the fluid product FP into the open end (3),
b) sealing the open end (3) to form the internal chamber (9),
wherein the filled and sealed vial provides a sealed container of the fluid product FP.

19. The method of claim 18, wherein:
the filling step comprises introducing the fluid product FP into the open end (3) via a filling needle (110),
the sealing step comprises heating and then sealing the open end (3) to form the internal chamber (9).

20. The dual-purpose vial of claim 1, wherein the vail is configured for the dosage of medicinal and pharmaceutical fluid products.
